(19) United States
(12) Patent Application Publication
(10) Pub. No.: US 2011/0000330 A1
(43) Pub. Date: Jan. 6, 2011

(54) BALL NUT OF A BALL SCREW

(75) Inventors: Wolfgang DOEPPLING, AURACHTAL (DE); Dieter ADLER, HERZOGENAURACH (DE); Horst STEINBINDER, GUNDELSHEIM (DE); Marco MEISBORN, HOECHSTADT A.D. AISCH (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/829,768

(22) Filed: Jul. 2, 2010

(30) Foreign Application Priority Data
Jul. 4, 2009 (DE) 10 2009 031 711.2

(51) Int. Cl. F16H 25/22; B21D 53/10

(52) U.S. Cl. 74/424.71; 29/898.07

(57) ABSTRACT

The ball nut of a ball screw at the inner circumference of which a ball groove is provided, wound helically about the longitudinal axis for rolling balls, and at its outer circumference a roller bearing is arranged for rotatably supporting the ball nut, wherein the roller bearing has an inner ring which is supported by means of a support ring arranged on the ball nut in the axial support direction, wherein the support ring is arranged as a result of material deformation in the axial support direction with positive engagement on the ball nut.

### FIELD OF THE INVENTION

The present invention relates to a ball nut of a ball screw. Ball screws are used for converting a rotatory movement into a translatory movement. They have a ball nut arranged on a threaded spindle, wherein balls roll along helically wound ball grooves of the ball nut and the threaded spindle with relative rotation between the threaded spindle and the ball nut.

### BACKGROUND OF THE INVENTION

An electrically driven power steering device has become known for motor vehicles from DE 101 93475 T1, in which a toothed rack has a portion which is constructed as a threaded spindle. FIG. 2 shows a partial longitudinal section of the toothed rack steering, wherein a ball nut is rotatably mounted on the threaded spindle with the intermediate arrangement of balls. The toothed rack with the portion for the threaded spindle is accommodated in a housing. The ball nut is rotatably mounted via a grooved roller bearing on this housing. The grooved roller bearing has an outer ring as well as an inner ring. The inner ring of the grooved ball bearing is axially supported on a shoulder of the ball nut on the one hand, and at a support ring on the other hand. In this manner, it is ensured that the inner ring is positioned in both axial directions properly on the ball nut and, thus, the ball nut is positioned and supported properly in the housing. The support ring has a threaded portion at its inner circumference. The ball nut has at its free end another threaded portion at its outer circumference, so that the support ring can be screwed onto the ball nut. The inner ring of the grooved roller bearing is axially clamped or positioned properly between the shoulder of the ball nut and the support ring.

In particular in such steering devices, it must be ensured that the ball nut is mounted properly in both axial directions. When the support ring is screwed on, there is the possibility that, due to vibrations, the adjusted position of the support ring changes, so that the inner ring is subjected to play in an undesirable manner in the axial directions. For avoiding such undesired changes of position of the support ring, a modified screw connection could be provided which, however, requires a higher manufacturing expense. Alternatively, a shaft securing ring could also be provided which engages in a circumferential groove of the ball nut. However, it is disadvantageous in this solution that a possibly required axial pretension between the shaft securing ring and the inner ring is virtually impossible to realize.

### OBJECT OF THE INVENTION

It was the object of the present invention to provide a ball nut of a ball screw according to the features of the preamble of claim 1 in which the inner ring can be positioned in a simple manner and properly on the ball nut.

### SUMMARY OF THE INVENTION

In accordance with the invention, this object was met in that the support ring is arranged with positive engagement on the ball nut by a material deformation in the axial supporting direction. The support ring can be plastically deformed by means of suitable deforming methods, preferably by beading or roller-burnishing, in such a way that it is pressed under a possibly desired axial pretension against the inner ring and, in addition, is arranged properly without further measures on the ball nut.

Positive engagement means that deformed material of the support ring is arranged in radial direction overlapping with at least a portion of the ball nut. Positive engagement may also mean that deformed material of the ball nut is arranged in radial direction overlapping with at least one portion of the support ring.

In a simple embodiment according to the invention, the ball nut may be provided, for example, with a groove extending in the circumferential direction, wherein deformed material of the support ring engages in the groove, so that the support ring is held properly in the axial directions. Instead of a groove it is also possible to provide only a shoulder on the ball nut, wherein deformed material of the support ring rests against this shoulder in one axial supporting direction. In the other axial direction, the support ring may be supported at another shoulder of the ball nut.

A particular advantage of the ball nut according to the invention may be seen in the fact that a possibly desired axial pretension between the support ring and the inner ring can be adjusted properly, as it may be required especially in a divided inner ring. If the roller bearing is constructed, for example, as a grooved ball bearing, the divided inner ring may have an inner ring part formed in one piece with the ball nut, as well as another separate inner ring part. The ball groove for rolling of the balls is in this case formed jointly at both inner ring parts. In such divided inner rings, the two inner ring parts are frequently arranged with an axial pretension relative to each other. The support ring can be slid onto the ball nut until the desired axial pretension between the support ring and the inner ring and, thus, between the two inner ring parts, is adjusted. Material of the support ring can now in a simple manner be formed into one or more recesses of the ball nut, so that the support ring is held and supported in the support direction in a positively engaging manner.

In a preferred further development of the invention, the support ring is roller-burnished in a roller-burnishing process onto the ball nut, wherein material of the support ring deformed by the roller-burnishing process is formed into a recess of the ball nut, particularly formed as a groove. In this roller-burnishing process, the support ring is guided onto the ball nut, subsequently a suitable roller-burnishing tool is moved to the support ring, and finally material of the support ring is plastically deformed by roller-burnishing by means of the roller-burnishing tool.

The roller-burnishing tool may have several rollers arranged so as to be distributed over the circumference of the support ring, wherein the rollers roll under radial load application of the support ring on the outer circumference of the ball nut, wherein material of the support ring is plastically deformed under the radial load.

In another preferred further development of the invention, the support ring is pressed in a beading process against the ball nut, wherein material of the support ring deformed by the beading process is formed into a recess of the ball nut, which is formed into a recess of the ball nut, particularly formed as a groove.

In a beading process, a suitable multi-piece tool is applied to the outer circumference of the support ring, wherein material of the support ring is plastically deformed only under radial and possibly axial load. This plastically deformed material can then engage in a positively engaging manner in the prepared recess of the spindle nut.

As a result of the material deformation, a shoulder or a board may be formed on the support ring, wherein the shoulder or board is supported in a positively engaging manner in the axial support direction at a portion of the ball nut.

The support ring may have a shoulder section facing the inner ring as support for the inner ring as well as a deforming section for the deformation by a deformation tool, wherein the shoulder section has a size smaller than the shoulder section for the deformation through a deformation tool. The deforming section has a thickness which is dimensioned in such a way that, on the one hand, a proper plastic deformation is ensured, wherein, however, on the other hand, a sufficiently stable support with positive engagement in the axial support direction is ensured.

### BRIEF DESCRIPTION OF THE DRAWINGS

In the following, the invention is explained in more detail with the aid of an embodiment reproduced in a total of three figures. In the drawing:

FIG. 1 Is a sectional view of a toothed rack steering of a motor vehicle with an electromechanical steering aid which is equipped with a ball nut according to the invention;

FIG. 2 shows a detail of the ball nut according to the invention; and

FIG. 3 shows an enlarged portion of the ball nut of FIG. 1.

### DETAILED DESCRIPTION OF THE DRAWINGS

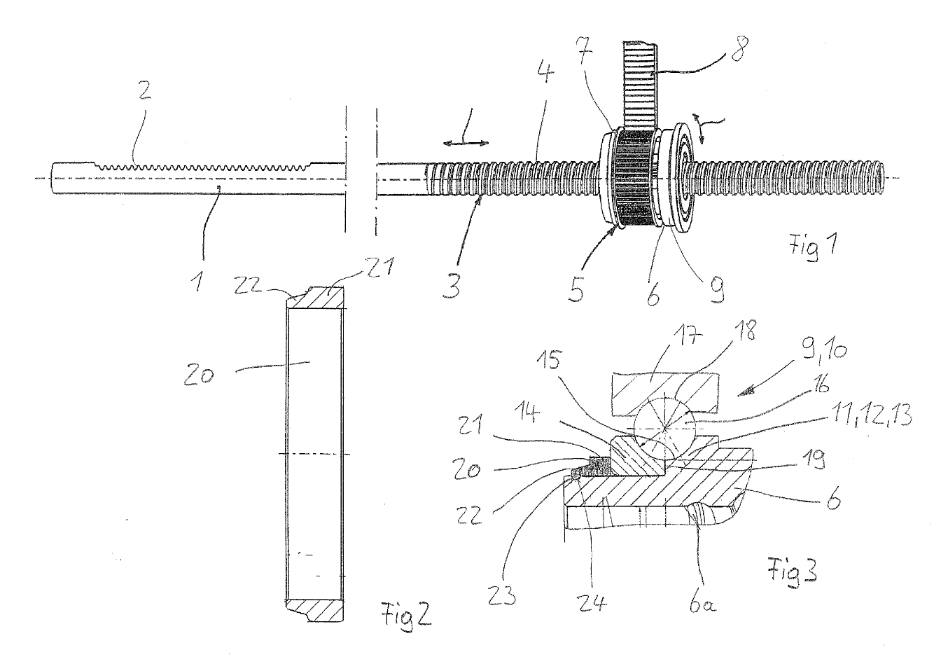

FIG. 1 shows a portion of a toothed rack steering system of a motor vehicle with an electromechanical steering aid. A toothed rack has a first portion 1 with a toothing 2, and a second portion 3 constructed as a threaded spindle 4. A ball screw 5, as it is known per se, is provided which has a ball nut 6 according to the invention with a belt disc 7 arranged on the ball nut so as to be not rotatable relative thereto. A toothed belt 8 surrounds the belt disc 7 and drives the ball nut 6.

The ball nut 6 is provided at an axial end thereof with a roller bearing 9 which is clearly illustrated in FIG. 3.

FIG. 3 shows a view of a detail of the ball nut 6 according to the invention. It can be seen from this view that the ball nut 6 is provided at its inner circumference with a helically wound ball groove 6a for the balls, not shown here. The balls are in engagement with the ball nut 6 as well as with the threaded spindle 4, so that an axial displacement of the toothed rack relative to the ball nut 6 takes place when the ball nut 6 rotates.

The ball nut 6 is radially mounted in a housing, not shown here, via the roller bearing 9 constructed as grooved ball bearing 10. Via this grooved ball bearing 10, the ball nut 6 according to the invention is positioned and held properly in both axial directions.

The grooved ball bearing 10 has a two-part inner ring 11 whose one inner ring part 12 is formed by a shoulder 13, which is integrally formed on the ball nut 6. Another inner ring part 14 is arranged on the ball nut 6, which together with the shoulder 13 forms a ball groove 15 for balls 16. The grooved ball bearing 10 additionally has an outer ring 17, which is provided at its inner circumference with another ball groove 18 for the balls 16.

The inner ring part 14 is axially supported at a shoulder 19 of the ball nut 6 on the one hand, and on a support ring 20 on the other hand. The inner ring part 14 is held without play between the support ring 20 and the shoulder 19 in the axial directions.

The support ring 20 has a shoulder section 21 facing the inner ring part 14, at which shoulder section 21 the inner ring part 14 is axially supported. Additionally, the support ring 20 has a deforming section 22 adjacent to the shoulder section 21 of smaller size as compared to the shoulder section 21, wherein a bead 23 formed by plastic deformation of the deformation section 22 engages in a groove 24 of the ball nut 6 with positive engagement. The positive engagement of the bead 23 formed by plastic deformation in a groove 24 ensures a proper support of the support ring 20 in the axial supporting direction, i.e., in the direction away from the inner ring part 14 and, if applicable, also additionally in the opposite axial direction. The forming of the bead 23 into the groove 24 takes place when the desired axial pretension of the inner ring 11 is adjusted.

FIG. 2 shows the support ring 20 prior to its plastic deformation, i.e., before a material deformation has been carried out. It can be seen clearly in this Figure that the deformation section 22 has not yet been provided with the bead 23 as it is shown in FIG. 3. The support ring 20 is moved onto the ball nut 6, as illustrated in FIG. 2, and is placed against the inner ring part 14. In the desired axial position, the deforming section 22 is now plastically deformed, so that material is displaced radially inwardly as a result of the material deformation.

In the present case, the deformation takes place as the result of a roller-burnishing process. For this purpose, a roller-burnishing tool, not shown here, has been placed on the already mounted support ring 20. This roller-burnishing tool conventionally has one or more rollers distributed over the circumference which roll under radial load at the circumference of the ball nut, and finally plastically deform material of the deformation section 22 in such a way that the bead 23 is formed.

### LIST OF REFERENCE NUMERALS

1 First section
2 Toothing
3 Second section
4 Threaded spindle
5 Ball screw
6 Ball nut
6a Helical ball groove
7 Belt disc
8 Toothed belt
9 Roller bearing
10 Grooved ball bearing
11 Inner ring
12 Inner ring part
13 Shoulder
14 Inner ring part
15 Ball groove
16 Balls
17 Outer ring
18 Ball groove
19 Shoulder
20 Support ring
21 Shoulder section
23 Deformation section
   23 Bead
   24 Groove

1. Ball nut of a ball screw at the inner circumference of which a ball groove is provided, wound helically about the longitudinal axis for rolling balls, and at its outer circumference a roller bearing is arranged for rotatably supporting the ball nut, wherein the roller bearing has an inner ring which is supported by means of a support ring arranged on the ball nut in the axial support direction, wherein the support ring is arranged as a result of material deformation in the axial support direction with positive engagement on the ball nut.

2. Ball nut according to claim 1, wherein the support ring is roller-burnished in a roller-burnishing process on the ball nut, wherein material of the support ring deformed by the roller-burnishing process is formed into a recess of the ball nut, particularly formed as a groove.

3. Ball nut according to claim 1, wherein the support ring is beaded to the ball nut in a beading process, wherein material of the support ring deformed by the beading process is formed into a recess of the ball nut particularly formed as a groove.

4. Ball nut according to claim 1, wherein the inner ring is divided, wherein an inner ring part is formed by an integrally formed shoulder of the ball nut, and by another inner ring part.

5. Ball nut according to claim 1, wherein the deformed material is formed as shoulder, bead or board.

6. Ball nut according to claim 1, wherein the support ring has a shoulder section facing the inner ring as support for the inner ring, as well as a deforming section for the deformation by means of a deforming tool, wherein the deforming section adjacent the shoulder section is smaller relative to the shoulder section.

7. Method for manufacturing a ball nut according to claim 1, wherein the inner ring and the support ring are arranged on the ball nut, and wherein material of the support ring is plastically deformed by roller-burnishing.

8. Method for the production of a ball nut according to claim 1, wherein the inner ring and the support ring are arranged on the ball nut, and wherein material of the support ring is plastically deformed by beading.
